(19) United States
(12) Patent Application Publication
(10) Pub. No.: US 2025/0104182 A1
(43) Pub. Date: Mar. 27, 2025

(54) AUTOMATIC GENERATION OF A REPROJECTION PANORAMIC VIEW FROM DENTAL DVT VOLUMES USING MACHINE LEARNING METHODS

(71) Applicants: DENTSPLY SIRONA Inc., York, PA (US); SIRONA DENTAL SYSTEMS GMBH, Bensheim (DE)

(72) Inventors: Marco BERTLEFF, Viernheim (DE); Tim BRAUN, Gross-Gerau (DE); Kai STANNIGEL, Weinheim (DE)

(73) Assignee: DENTSPLY SIRONA Inc., York, PA (US)

(21) Appl. No.: 18/290,839

(22) PCT Filed: Jul. 11, 2022
(86) PCT No.: PCT/EP2022/069254

§ 371 Date: Jan. 22, 2024

(30) Foreign Application Priority Data
Jul. 23, 2021 (EP) 21187468.0

(51) Int. Cl. G06T 3/06; G06T 7/11

(52) U.S. Cl. CPC G06T 3/06; G06T 7/11; G06T 2207/30036

(57) ABSTRACT

The present invention relates to a method for automatically generating a projection panoramic view (RPV) from a dental DVT volume of a patient, comprising the steps of; (S1) localizing dental relevant anatomical structures in the DVT volume by using a machine learning method; (S2) automatically placing a guide curve by optimizing it based on the position of the localized dental relevant anatomical structures; (S3) defining a projection region of the reprojection panoramic view using the placed guide curve without manual steps in the DVT volume so that the localized dental relevant anatomical structures are encompassed; (S4) creating the reprojection panoramic view by reprojecting the DVT volume in the defined projection region.

### TECHNICAL FIELD OF THE INVENTION

The present invention relates to a method for generating a reprojection panoramic view (RPV) from a dental DVT volume of a patient.

### BACKGROUND OF THE INVENTION

In the field of dental diagnostics, the panoramic tomogram is an established and important tool that allows an overview of all teeth as well as the bony structures of the facial skull (jaw bones, joints and cavities) in a single image. It can be created directly by specialized imaging systems.

However, if a DVT imaging is primarily required for the examination of a patient, or if only one such imaging is available from previous examinations, an overview that is close in content to the panoramic tomogram can also be calculated with software support by reprojecting the three-dimensional image data from the DVT volume (referred to in the following as a reprojection panoramic view or RPV). FIG. 1 shows a typical RPV. To create an RPV from a DVT volume, a curved subregion of the volume dataset is typically selected that encloses the dental-relevant anatomical structures (such as the jaw arch) as closely as possible. This three-dimensional subregion (referred to as the projection region in the following) is then projected onto its two-dimensional outer or inner lateral surface (usually by accumulating the image data along the normal of the curvature line) and the result is subsequently displayed as a planar 2D image.

A completely free, manual definition of the projection region of an RPV in three dimensions is associated with a high effort and a high demand on the spatial imagination of a user. Therefore, many existing systems (e.g. Sicat Implant, Sidexis4, Sante Dental) use instead a guide curve defined with respect to the patient in the transversal section plane, which is initially extended to a two-dimensional surface in the transversal plane with the help of an adjustable thickness (D′). FIG. 2 shows a guide curve (dashed line) in a transversal section plane of a DVT volume different from the basis for FIG. 1. The section of the anterior and posterior boundary surfaces of the derived projection region with the transversal plane is shown with solid lines.

The three-dimensional projection region in the DVT volume is then determined from this two-dimensional surface by linear extrusion along the patient's longitudinal axis. FIG. 3 shows an anterior and posterior boundary surface of the three-dimensional projection region after linear extrusion of a guide curve along the patient longitudinal axis (z). The example in FIG. 1 shows the RPV of a skull with a dental anatomy favorable for prior art reprojection, where the maxilla and mandible have relatively similar shapes and overlap well along the patient's longitudinal axis. Therefore, all relevant anatomical structures are also mapped in the RPV.

Due to the simplified determination of the projection region (specification of a two-dimensional guide curve only and subsequent linear extrusion into the third dimension), it is easier to manually determine a region for the RPV, but the problem often arises that the anatomy of the jaw arch does not completely fit into the ‘vertically upward’ extruded projection region. Often, in such cases, it is possible to select the position of the guide curve so that one jaw arch is well covered but the other is not. An example of an RPV in a skull with such dental anatomy unfavorable to prior art reprojection is shown in FIGS. 4 and 5. Here, the mandible and maxilla are offset from each other. FIG. 2 shows a guide curve that fits well with the mandible (left: transversal plane with guide curve (dashed line) and projection region (between solid lines). Right: resulting RPV with positional indication of the height of the transversal plane shown on the left). FIG. 3 now shows this guide curve from FIG. 4 in a transversal plane located in the maxilla. It can be clearly seen that the curve is a poor fit to the maxilla and therefore the anterior teeth protruding from the resulting projection region (within the ellipse) are not mapped in the RPV. By choosing a high thickness when determining the projection region from the guide curve, the chance increases that offset overlying maxillae and mandibles are still both included in the projection region. The disadvantage of this approach, however, is that the bone structures become more blurred and the overall contrast of the RPV decreases as a result of the soft tissue components that are increasingly included at the same time. Overall, the creation of RPVs according to the state of the art is therefore problematic in patients with unfavorable anatomy.

Although placing the guide curve makes it easier for the clinician to determine the projection region, this manual processing step continues to be time consuming for the clinician. To avoid this, methods for automatically generating a guide curve for RPVs are known that use approaches from image processing, such as threshold segmentations or edge detections, to detect the bony dental arch in one or more transversal slices and then place a guide curve through this detected region. However, these approaches with image processing can easily misidentify the region of interest in the presence of image artifacts such as bright over-illumination due to metal shadowing, and thus subsequently lead to an RPV that does not optimally image all dental-relevant structures imaged in the DVT volume.

### DISCLOSURE OF THE INVENTION

One objective of the present invention is to provide a method for automatically generating an RPV from a dental DVT volume of a patient, which fully images the dental relevant anatomical structures of the imaged patient, while requiring no manual input from the user.

The objective is achieved by the method according to claim 1. The subject-matters of the dependent claims define further developments and preferred embodiments.

The method according to the invention is for automatically generating a reprojection panoramic view (RPV) from a dental DVT volume of a patient. The method comprises the following steps of: localizing dental relevant anatomical structures in the DVT volume by using a machine learning method; automatically placing a guide curve by optimizing it based on the position of the localized dental relevant anatomical structures; defining a projection region of the reprojection panoramic view using the placed guide curve without manual steps in the DVT volume so that the localized dental relevant anatomical structures are encompassed; creating the reprojection panoramic view by reprojecting the DVT volume in the defined projection region.

An advantageous effect of the invention is that it improves the automatic placement of the guide curve, since it searches much more directly and specifically for the anatomical structures that are also dental relevant for the physician compared to known image analysis methods. Therefore, it is less affected by general image artifacts, variations in the optical densities of the imaging, and varying noise characteristics than, for example, threshold filtering or edge detection.

### BRIEF DESCRIPTION OF THE DRAWINGS

In the following description, the present invention will be explained in more detail with reference to exemplary embodiments and with reference to the drawings, wherein.

FIG. 1—shows a typical reprojection panoramic view according to the prior of the art;

FIG. 2—shows a guide curve of the manually derived projection area in a transversal section plane of a DVT volume according to the prior of the art;

FIG. 3—shows a projection region determined by linear extrusion from a guide curve according to the prior of the art;

FIG. 4—shows a guide curve with a projection range derived according to the prior of the art that fits well with a mandibular arch imaged in the DVT volume;

FIG. 5—shows the same guide curve with a projection range derived according to the prior of the art that poorly matches a maxillary arch imaged in the DVT volume;

FIG. 6—shows a transverse section through a projection region locally adapted to dental relevant anatomical structures according to one embodiment of the invention;

FIG. 7—shows a three-dimensional representation of a projection region from FIG. 6 adapted to the dental-relevant anatomical structures;

FIG. 8—shows a reprojection panoramic view according to one embodiment of the invention;

FIG. 9—shows a schematic diagram of a DVT X-ray system according to one embodiment of the invention.

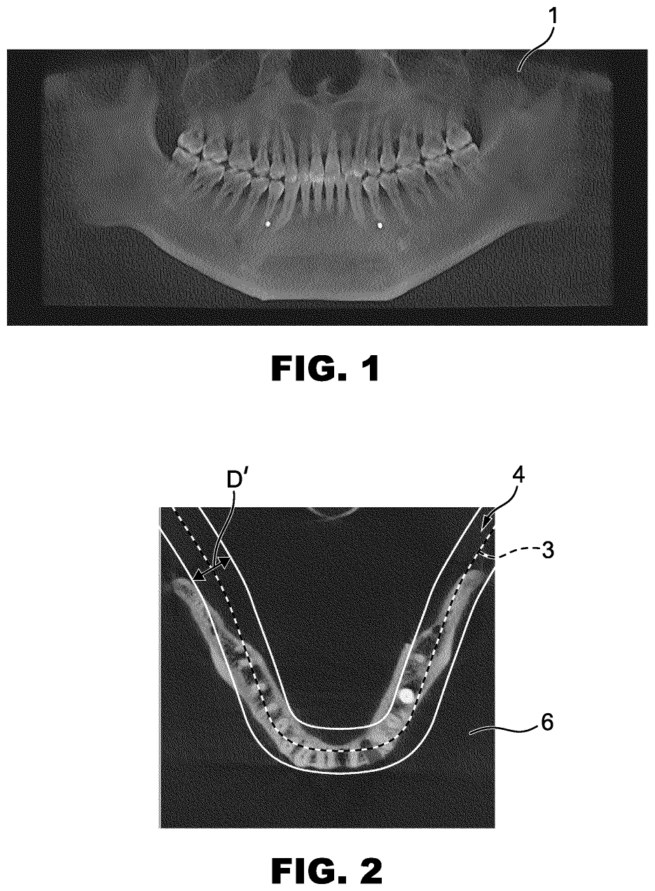

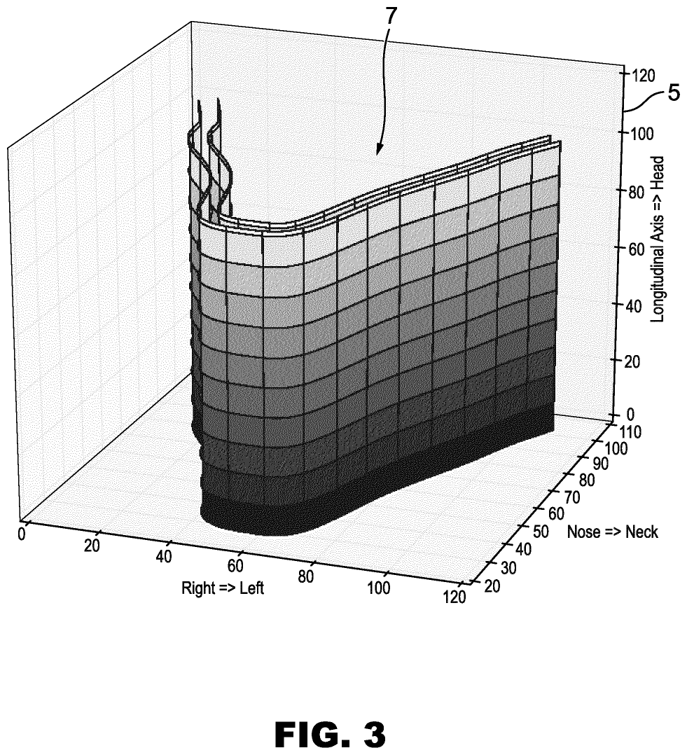

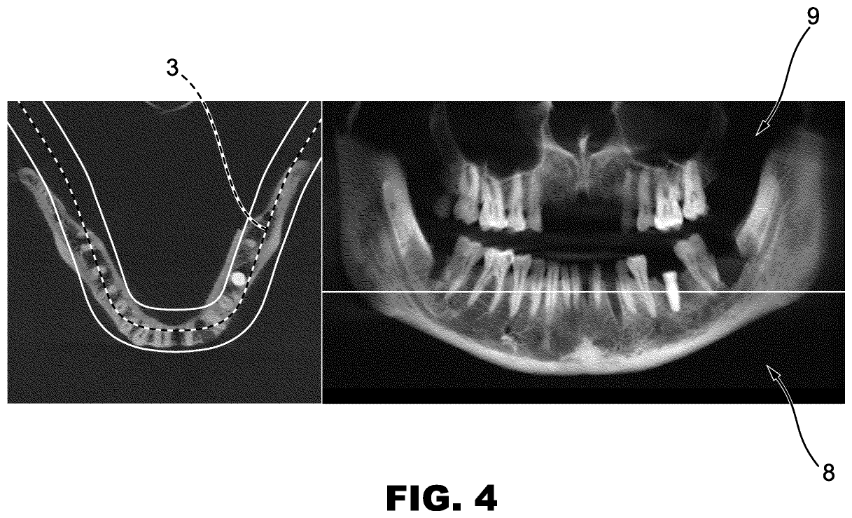

The reference numerals shown in the drawings designate the elements listed below, which will be referred to in the following description of the exemplary embodiments.
1. Reprojection Panoramic View (RPV)
2. Dental relevant anatomical structure
3, 3′ Guide curve, Curve
4. Projection Region
5. Vertical extrusion axis
6. Transverse section plane
7. Linear extrusion
8. Mandibular arch
9. Upper arch
10. Knot points
11. Center points
12. DVT system
13. X-ray device
14. X-ray source
15. X-ray detector
16. Control unit
17. Head fixation
18. Bite
19. Computer
20. Display
D: Thickness of the projection region (4) (in the transverse section plane (6)).

The method according to the invention is used to automatically generate a reprojection panoramic view (1) from a dental DVT volume of a patient.

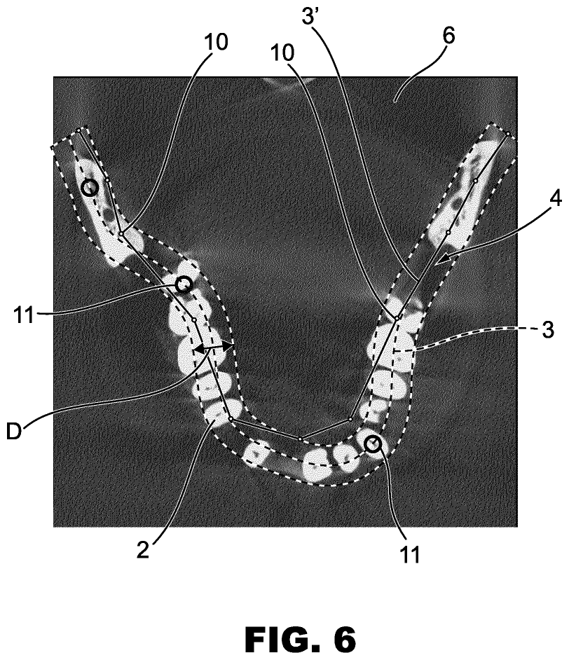

The method comprises steps S1 to S4. In step S1, dental relevant anatomical structures (2) are localized in the DVT volume by using a machine learning method. FIG. 6. shows a transverse section plane (6) in the DVT volume with the localized dental relevant anatomical structures (2).

The dental relevant anatomical structures (2) can be the following structures: temporomandibular joint, jawbone, teeth, root tips, implants, foramen mandibulae, foramen mentale, foramen incisivum, foramen palatinum majus, foramen infraorbitale, processus coronoideus, spina nasalis anterior, spina nasalis posterior, canalis mandibularis, canalis incisivus.

In step S2, a guide curve (3) is automatically placed by optimizing it based on the position of the localized dental relevant anatomical structures (2). The placement and optimization will be explained in more detail below. FIG. 6. shows a transversal section plane (6) in the DVT volume in which the guide curve (3) is placed.

In step (S3), a projection region (4) of the reprojection panoramic view (1) is defined using the placed guide curve (3) without manual steps in the DVT volume so that the localized dental relevant anatomical structures (3) are encompassed. FIG. 6. shows a transverse section plane (6) in the DVT volume with the defined projection region (4) encompassing the localized dental relevant anatomical structures (3).

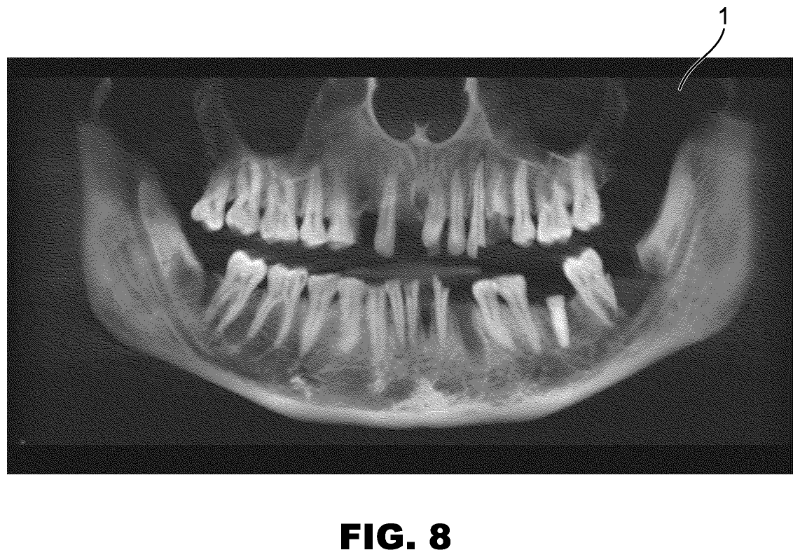

In step S4, the reprojection panoramic view (1) is generated by reprojecting the DVT volume in the defined projection region (4). FIG. 8 shows a reprojection panoramic view (1) generated by this method.

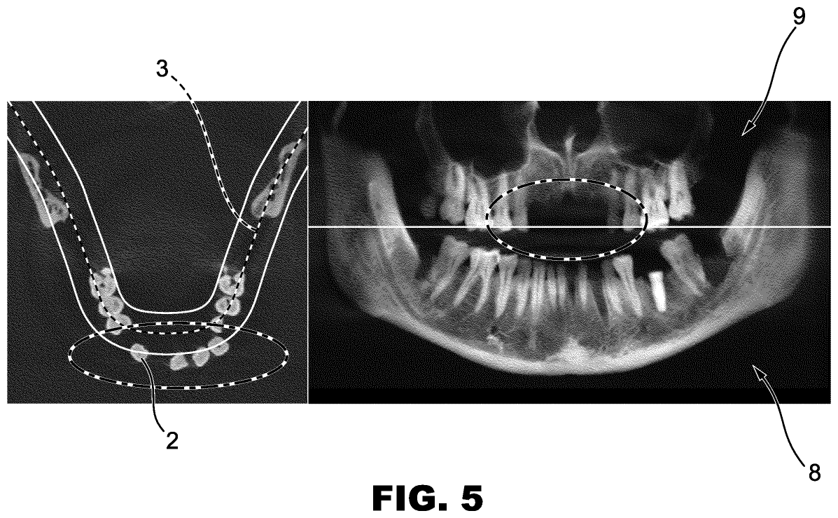

The RPV resulting from the projection region of FIG. 6 is shown in FIG. 8. It can be clearly seen that the anatomy-fair adjustment of the projection region results in all incisor teeth of the maxilla being imaged. This illustrates the positive effect of the invention, which is particularly clear in direct comparison with the region marked by an ellipse in FIG. 5, where the incisor teeth are not displayed.

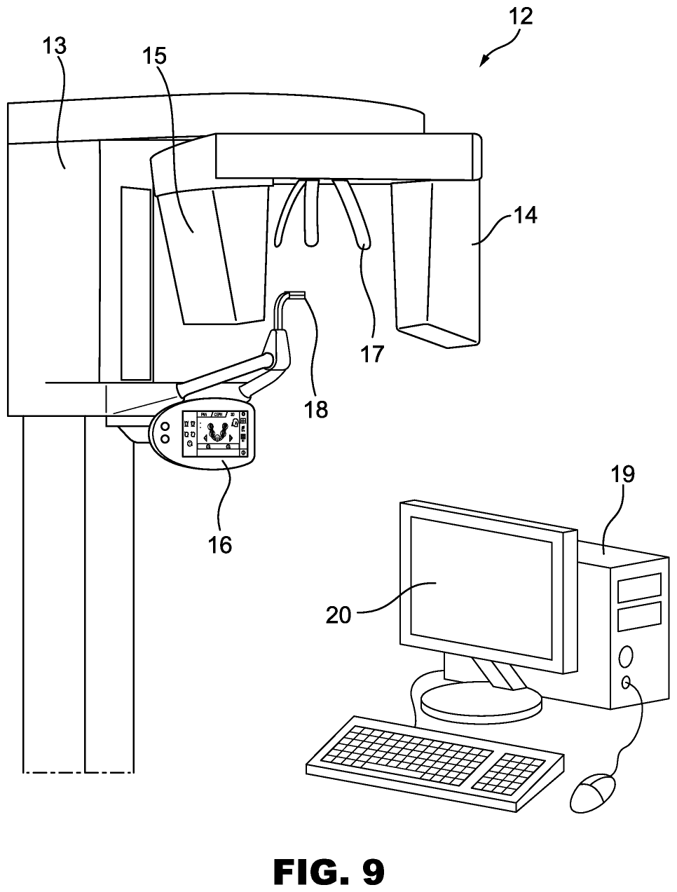

In step S1, the method uses a machine learning method, in particular a neural network, which can be implemented by a hardware or software. The neural network will be explained in detail later in the following description. The DVT volume is provided to the neural network by a DVT X-ray system (12). FIG. 9 shows an example embodiment of a DVT X-ray system (12) providing raw image data for the DVT volume. The method according to the invention is a computer-implementable method and can be implemented on a computer (19) on which the calculations of the outputs of the neural network are performed through given inputs of the DVT volume. As shown in FIG. 9, the computerized DVT system (12) includes an X-ray device (13) for performing patient imaging, generating single 2D images or a sinogram. The X-ray device (13) has an X-ray source (14) and X-ray detector (15), which are rotated around the patent head during imaging. The patient's head is positioned in the X-ray device with the bite (18) and head fixation (17). The computerized DVT-X-ray system (12) comprises a control unit (16), preferably the computer (19) or a computing unit connectable to the X-ray device (13), and preferably a display (20), inter alia to visualize the data sets. The computer (19) may be connected to the X-ray apparatus (13) via a local area network (not shown) or alternatively via the Internet. The computer (19) may be part of a cloud. Alternatively, the computer (19) may be integrated into the X-ray device (13). The calculation of the DVT volume may alternatively take place in the cloud. The computer (19) executes the computer program and provides the data sets, including for visulization on the display (20). The display (20) may be spatially separated from the x-ray device (13). Preferably, the computer (19) may also control the X-ray device (13). Alternatively, separate computers may be used for the control and the reconstruction. For this purpose, the present invention also comprises a computer program with computer readable code. The computer program may be provided on a data storage device locally or in the cloud.

The neural networks can be provided integrated with the DVT system (12). Alternatively, the neural networks may be provided separately. The DVT system (12) can be connected to the neural networks locally or via a network.

According to the present invention, the data sets generated by the above embodiments may be presented to a physician for visualization, in particular for diagnostic purposes, preferably by means of a display (20) or printout.

In alternative embodiments, different variants may be used in the localization step S1:

In a first embodiment S1.1, the centers points (11) (see FIG. 6) of the dental relevant anatomical structures (2) are localized by applying at least one trained CNN to transform the DVT volume into heat maps indicating the position of the dental relevant anatomical structures (2) by voxels lying above a threshold value. FIG. 6. shows a transverse section plane (6) in the DVT volume with the centers points (11) of the localized dental relevant anatomical structures (2). This embodiment has the advantage that the resolution of the DVT image data required to localize the center points is low compared to other embodiments, and therefore the neural network application can be performed on a downscaled version of the DVT volume. This accelerates the computations enormously, since with three-dimensional volume data e.g. a halving of the resolution leads to the fact that only ⅛ of the image elements must be processed. For the user, a delay in the provision of the RPV can thus be avoided.

In a second embodiment S1.2, the dimensions of the dental relevant anatomical structures (2) are located and determined using a trained machine learning method which calculates bounding boxes (not shown) around the respective structures. This embodiment has the advantage that the overall dimensions of said structures (2) are more accurately known when determining the projection region (4), and therefore the projection region (4) can be better captured. Also, an adaptive choice of the thickness (D) of the projection region is thus possible. An adaptive choice of thickness may be made such that all bounding boxes intersected in a plane are just encompassed. Alternatively, a thickness profile pre-determined along the curve may be used.

In a third variant S1.3, the exact shape of the dental relevant anatomical structures (2) is determined by a trained machine learning method that outputs segmentation masks (not shown). This embodiment has the advantage that the complete information about the exact shape of the anatomical structures (2) is available, and thus the projection region (4) can be optimally adapted to them.

The neural networks used in variants S1.1, S1.2, and S1.3 can be trained by data pairs that have DVT volumes and annotations. These annotations are heatmaps in the localization variant (S1.1), bounding boxes in the localization variant (S1.2), and segmentation masks in the localization variant (S1.3). These can be generated automatically or manually.

In one embodiment, the guide curve (3) results as follows. The curve (3′) (see FIG. 6) can be defined by freely selectable knot points (10) and an interpolation rule (e.g. spline or polynomial). Alternatively, the curve (3′), is selected from a set of given curve shapes and adapted under geometric transformations (e.g. translation, rotation, deformation or scaling). The free choice of knot points (10) has the advantage that the guide curve (3) can already optimally reproduce the course common to all dental-relevant anatomical structures (2), and thus the local adjustments of the projection region (4) can be reduced. Restricting the guide curve (3) to predetermined curve shapes, on the other hand, has the advantage that the shapes are already similar to the user from existing systems, and the image impressions resulting from the shape are preserved. This makes it easier for the user to interpret the RPV.

In one embodiment, optimization is performed with respect to one or more of following criteria (i), (ii), and (iii):

According to a first criterion (i), for example, the sum of the distances between the guide curve (3) and the localized dental relevant anatomical structures (2) can be minimized. The following may be used as distance measures: a) sum of the distances between the structures (2) and their nearest perpendicular points on the guide curve (3); or b) weighted sum of the distances between said structures (2) and their nearest perpendicular points on the guide curve (3), using a different weight depending on the anatomical structure (2) and/or curve region, the distances being calculated by any arbitrary distance metric.

According to a second criterion (ii), the aesthetics of the resulting reprojection panoramic view (1) can be obtained. As a measure for the aesthetics at least one of the further following criteria can be taken as a basis: local distortions of the RPV (1), imaging-related asymmetry of the RPV (1).

According to a third criterion (iii), in the case of curves (3) spanned by freely chosen knot points (10), the curve complexity, which is determined by the number of knot points (10) or degree of a polynomial, can be limited.

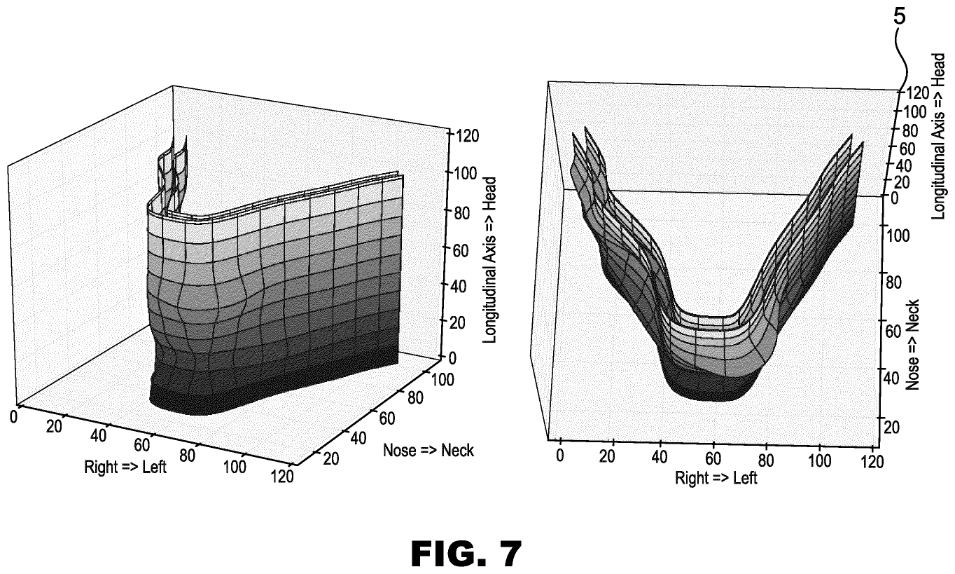

In the following, the defining step (S3) is explained in more detail according to one of the embodiments. As shown in FIG. 7, in the defining step (S3), the projection region (4) in the transversal planes (6) in which dental relevant anatomical structures (2) were found in the locating step (S1) is shifted along the respective projection direction (i.e., the normals of the guide curve), respectively, in such a way that the projection region (4) passes through the dental relevant anatomical structures (2). The necessary displacement of the projection region (4) is preferably interpolated between a full displacement in the transversal planes (6) with dental relevant structures and no displacement from a suitably chosen distance between the relevant structures and the guide curve. This ensures that a found structure (2) only influences the shape of the projection region (4) in its three-dimensional spatial environment. When choosing the interpolation function, various approaches such as a radial Gaussian function are possible. An example of such a local adaptation of the projection region (4) can be seen in FIG. 6 and FIG. 7. A dental relevant anatomical structure (2) (the upper canine tooth) causes a shift of the projection region center outwards, by interpolation this goes back to the initial position with increasing distance.

In a preferred further embodiment, the projection area (4) is preferably determined in the definition step (S3) by extending the guide curve (3) in a transverse section plane (6) with respect to the patient to form a two-dimensional surface with a fixed thickness or a thickness profile determined in advance along the curve in the transverse plane and then extruding this surface along the patient's longitudinal axis. Whereby, the projection region (4) in the transversal section planes in which dental relevant anatomical structures (2) were found in the localization step (S1) is locally displaced along the respective projection direction in each case in such a way that the projection region (4) passes through the dental relevant anatomical structures (2). Whereby the thickness (D) of the projection region (4) is automatically selected either locally or globally in such a way that the dental relevant anatomical structures (2) lie completely or for the most part within the projection regions (4).

1. A method for automatically generating a reprojection panoramic view (RPV) from a dental DVT volume of a patient, comprising;
(S1) localizing dental relevant anatomical structures in the DVT volume by using a machine learning method;
(S2) automatically placing of a guide curve by optimizing the guide curve based on the position of the localized dental relevant anatomical structures;
(S3) defining a projection region of the reprojection panoramic view using the placed guide curve without manual steps in the DVT volume so that the localized dental relevant anatomical structures are encompassed;
(S4) creating the reprojection panoramic view by reprojecting the DVT volume in the defined projection area.

2. The method according to claim 1, wherein said localizing comprises one of the following variants:
(S1.1) localizing centers of the dental relevant anatomical structures by applying at least one trained CNN to transform the DVT volume into heat maps indicating the position of the dental relevant anatomical structures by voxels lying above a threshold value;
(S1.2) localizing and determining dimensions of the dental relevant anatomical structures using a trained machine learning method that outputs bounding boxes; or
(S1.3) localizing and determining an exact shape of the dental relevant anatomical structures using a trained machine learning method that outputs segmentation masks.

3. The method according to claim 1, wherein the guide curve results are as follows: a curve definable by freely selectable knot points and an interpolation rule;
another curve which is selected from a set of predetermined curve shapes and can be adapted under geometric transformations.

4. The method according to claim 1, wherein the optimizing is performed with respect to one or more of the following criteria:
minimizing a distance measure between the guide curve and the localized dental relevant anatomical structures, the distance measures being:
a) sum of distances between the structures and their nearest perpendicular points on the guide curve;
b) weighted sum of the distances between said structures and their nearest perpendicular points on the guide curve, using a different weight depending on the anatomical structure and/or curve region, the distances being calculated by any arbitrary distance metric;
maintaining the aesthetics of the resulting RPV, wherein the measure of aesthetics is based on at least one of the following criteria: Avoidance of local distortions of the RPV, Reduction of imaging-induced asymmetry of the RPV;
in a case of curves spanned by freely selected knot points, limitation of a curve complexity, which is determined by a number of knot points or degree of a polynomial.

5. The method according to claim 1, wherein the dental relevant anatomical structures are at least one of the following structures: Temporomandibular joint, jawbone, Teeth, Root tips, Implants, Foramen Mandibulae, Foramen Mentale, Foramen incisivum, Foramen Palatinum Majus, Foramen infraorbitale, Processus coronoideus, Spina Nasalis Anterior, Spina Nasalis Posterior, canalis mandibularis, canalis incisivus.

6. The method according to claim 1, wherein in (S3) the projection region is determined by extending, in a sectional plane transverse with respect to the patient, the guide curve to a two-dimensional surface having a fixed thickness or a thickness profile predetermined along the curve in the transverse plane, and subsequently extruding said surface along the longitudinal axis of the patient.

7. The method according to claim 6, wherein in (S3), the projection region in the transverse sectional planes in which dental-relevant anatomical structures are found in the localizing step (S1) is locally displaced along the respective projection direction in each case in such a way that the projection region runs through the dental-relevant anatomical structures.

8. The method according to claim 7, wherein the necessary displacement of the projection region is interpolated between the full displacement in the transversal sectional planes with dental relevant structures and no displacement starting from a suitably chosen distance between the relevant structures and the guide curve.

9. The method according to claim 6, wherein in (S3) the thickness (D) of the projection region is automatically selected either locally or globally such that the dental relevant anatomical structures lie completely or for the most part within the projection region.

10. A method according to claim 2, wherein in (S1) for training data pairs comprise DVT volumes and annotations, said annotations having
in (S1.1), heat maps
in (S1.2) bounding boxes
in (S1.3) segmentation masks

11. A non-transitory computer-readable storage medium, including instructions that when executed by a computer, cause the computer to:
(S1) localize dental relevant anatomical structures in the DVT volume by using a machine learning method;
(S2) automatically place a guide curve by optimizing the guide curve based on the position of the localized dental relevant anatomical structures;
(S3) define a projection region of the reprojection panoramic view using the placed guide curve without manual steps in the DVT volume so that the localized dental relevant anatomical structures are encompassed;
(S4) create the reprojection panoramic view by reprojecting the DVT volume in the defined projection area.

12. Computerized DVT system comprising an X-ray device, a processor; and a memory storing instructions that, when executed by the processor, configure the apparatus to:
(S1) localize dental relevant anatomical structures in the DVT volume by using a machine learning method;
(S2) automatically place a guide curve by optimizing the guide curve based on the position of the localized dental relevant anatomical structures;
(S3) define a projection region of the reprojection panoramic view using the placed guide curve without manual steps in the DVT volume so that the localized dental relevant anatomical structures are encompassed;
(S4) create the reprojection panoramic view by reprojecting the DVT volume in the defined projection area.

13. (canceled)
